(19) United States
(12) Patent Application Publication
(10) Pub. No.: US 2013/0300770 A1
(43) Pub. Date: Nov. 14, 2013

(54) LED Backlight Driving Circuit, Liquid Crystal Display Device, and Driving Method

(71) Applicants: Xiang Yang, Shenzhen (CN); Poshen Lin, Shenzhen (CN); Liangchan Liao, Shenzhen (CN)

(72) Inventors: Xiang Yang, Shenzhen (CN); Poshen Lin, Shenzhen (CN); Liangchan Liao, Shenzhen (CN)

(21) Appl. No.: 13/518,954

(22) PCT Filed: May 16, 2012
(86) PCT No.: PCT/CN2012/075593

§ 371 Date: Jun. 25, 2012

(30) Foreign Application Priority Data
May 9, 2012 (CN) 201210142061.2

(51) Int. Cl. G09G 3/36; H05B 37/02; G09G 5/10

(52) U.S. Cl. 345/690; 315/192; 345/102

(57) ABSTRACT

The invention discloses an LED backlight driving circuit, an LCD device, and a driving method. The LED backlight driving circuit includes a plurality of LED light strings which are arranged in parallel; each LED light string is correspondingly connected with a dimming branch in series. The LED backlight driving circuit further includes a plurality of controllable disconnectors; one end of the controllable disconnector is connected to at least two LED light strings, and the other end of the controllable disconnector is connected with an equal amount of dimming branches; at the moment, only one of the dimming branches connected with the same controllable disconnector can be conducted. In the invention, on the premise of ensuring that the whole brightness is not variously reduced, the number of the controllable disconnector can be reduced by sharing the same controllable disconnector, thereby reducing the cost.

### TECHNICAL FIELD

The invention relates to the field of liquid crystal displays (LCDs), and more particularly to a light emitting diode (LED) backlight driving circuit, an LCD device, and a driving method.

### BACKGROUND

The LCD device includes an LCD panel and a backlight module. In a conventional backlight module, an LED is used as a light source; because a brightness of one LED is limited, a plurality of LEDs are used in series to form an LED light string. For a large size LCD device, a plurality of LED light strings are required to connect in parallel to satisfy the brightness requirement. Generally the dimming of the LED light strings is achieved by connecting a dimming branch in series. As shown in FIG. 1, each LED light string is connected with a dimming Metal Oxide Semiconductor (MOS) tube (Q20˜Q25) in series. When the LED light string is short-circuited, all voltages are loaded to the dimming MOS tube, and the dimming MOS tube will be broken down; thus, a controllable disconnector is generally connected in series between the LED light string and the dimming MOS tube, such as an isolated MOS tube (Q10˜Q15) shown in FIG. 1. However, a plurality of LED light strings need a corresponding amount of the isolated MOS tube to work, causing that the cost is greatly increased.

### SUMMARY

In view of the above-described problems, the aim of the invention is to provide a low-cost LED backlight driving circuit, an LCD device, and a driving method.

The purpose of the invention is achieved by the following technical schemes:

An LED backlight driving circuit comprises a plurality of LED light strings which are arranged in parallel; each LED light string is correspondingly connected with a dimming branch in series. The LED backlight driving circuit further comprises a plurality of controllable disconnectors; one end of the controllable disconnector is connected with at least two LED light strings, and the other end of the controllable disconnector is connected with the dimming branch which is equal amount to the LED light string. Only one of the dimming branches connected with the same controllable disconnector can be conducted at the moment.

Preferably, the LED backlight driving circuit further comprises a brightness compensation module, which makes a practical brightness outputted by the conducted LED light string to exceed a preset brightness. Because a successive conduction mode of the LED light string inevitably reduces a brightness of the whole backlight module, the brightness loss of the whole backlight module can be compensated by enhancing the brightness outputted by one LED light string, so that the average brightness of the invention is almost constant with the brightness of the prior art; thus, the cost is reduced, and display quality is also ensured.

Preferably, the dimming branches connected with the same controllable disconnector are successively and alternately conducted in a time sequence. Only the dimming branches connected with the same controllable disconnector are successively and alternately conducted in the time sequence; thus, at the same time sequence frequency, one controllable disconnector can control many LED light strings and dimming branches thereof, thereby reducing the cost.

Preferably, all the dimming branches are successively and alternately conducted in the time sequence. A polling control mode is used for controlling the successive conduction of the dimming branches, and the control mode is simple.

Preferably, the controllable disconnector comprises an isolated MOS tube. A source electrode of the isolated MOS tube is connected with the LED light string; a drain electrode of the isolated MOS tube is connected with the dimming branch; a gate electrode of the isolated MOS tube is coupled to a power output end of the LED backlight driving circuit. The dimming branch comprises a dimming MOS tube. This is a specific circuit structure; the MOS tube is used for the controllable disconnector and the dimming branch, which improves the material generality and reduces the cost of designing and purchasing.

An LCD device comprises the LED backlight driving circuit mentioned above.

A method for driving an LED backlight comprises the following steps:

A: Sharing one controllable disconnector for at least two LED light strings and dimming branches thereof;

B: Controlling the dimming branch to ensure that only one of the dimming branches connected with the same controllable disconnector can be conducted at the moment.

Preferably, in the step B: the conducted dimming branch is controlled by a brightness compensation module, which makes a practical brightness outputted by the corresponding LED light string to exceed a preset brightness. Because a successive conduction mode of the LED light string inevitably reduces a brightness of the whole backlight module, the brightness loss of the whole backlight module can be compensated by enhancing the brightness outputted by one LED light string. Thus, the average brightness of the invention is almost constant with the brightness of the prior art; the cost is reduced, and display quality is also ensured.

Preferably, in the step B: the conducting time of one dimming branch is set as a time sequence for controlling all the dimming branches to be successively and alternately conducted in the time sequence. A polling control mode is used for controlling that the dimming branches are successively conducted, and the control mode is simple.

Preferably, prior to the step A: computing a reciprocal of a maximum duty cycle of one LED light string; taking an integer of the reciprocal of the maximum duty cycle as the number of the dimming branches connected with one controllable disconnector. Thus, there is no need to deliberately control the conducting time of one dimming branch; as long as the starting time of the dimming branches connected with the same controllable disconnector is successively staggered, the dimming branches connected with the same controllable disconnector will not be conducted at the same time; the control mode is simple. For example, the maximum duty cycle of one LED light string is 1/3, and one period time is T, one controllable disconnector is connected with three dimming branches; the first dimming branch is conducted at T/3; the second dimming branch is conducted at 2T/3; the third dimming branch is conducted at T.

In the invention, because a plurality of LED light strings and dimming branches thereof share one controllable disconnector, as long as only one of dimming branches connected with the same controllable disconnector is conducted at the moment, the controllable disconnector will not perform overload operation. When the switching frequency of the dimming branch is high enough, the whole brightness of the LED light strings will not be obviously reduced. Thus, on the premise of ensuring that the whole brightness is not obviously reduced, the number of the controllable disconnector can be reduced by sharing the controllable disconnector connected with at least two LED light strings, thereby reducing the cost.

### BRIEF DESCRIPTION OF FIGURES

FIG. 1 is a schematic diagram of a conventional circuit;

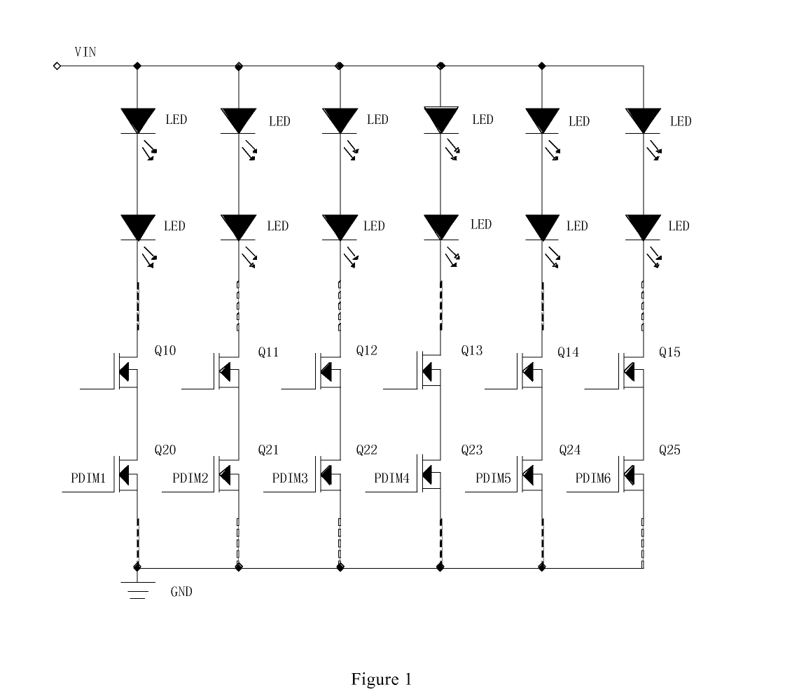

FIG. 2 is a schematic diagram of a circuit of an example of the invention; and

FIG. 3 is a schematic diagram of a driving waveform of an example of the invention.

### DETAILED DESCRIPTION

The invention will further be described in detail in accordance with the figures and the preferable examples.

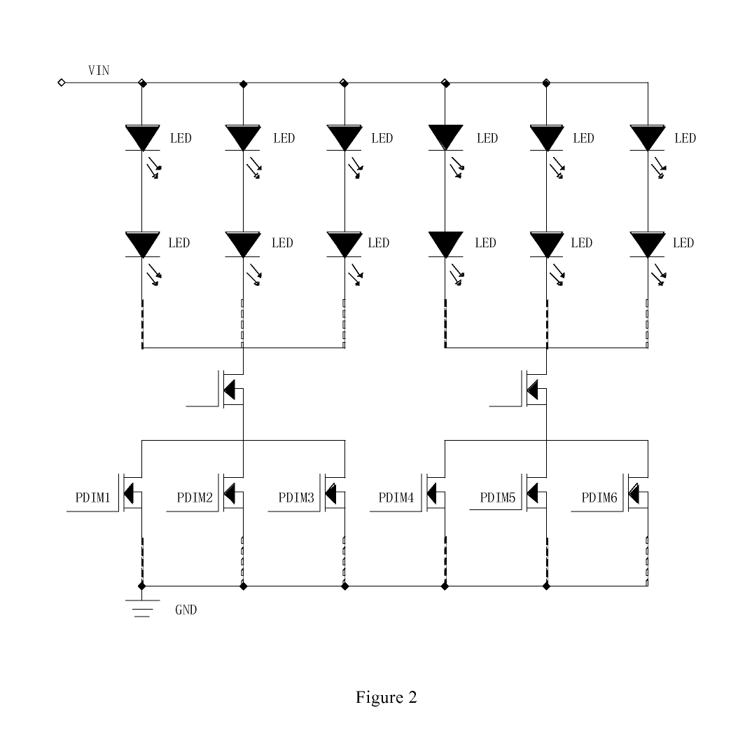

As shown in FIG. 2, an LCD device comprises the LED backlight driving circuit mentioned above. The LED backlight driving circuit comprises a plurality of LED light strings arranged in parallel; each LED light string is correspondingly connected with one dimming branch in series. The LED backlight driving circuit further comprises a plurality of controllable disconnectors; one end of the controllable disconnector is connected with at least two LED light strings; the other end of the controllable disconnector is connected with an equal amount of dimming branches. At the moment, only one of the dimming branches connected with the same controllable disconnector can be conducted. A complete polling mode can be adopted for controlling all the dimming branches to be successively and alternately conducted in a time sequence, and a local polling mode can also be adopted, the dimming branches connected with the same controllable disconnector are successively and alternately conducted in the time sequence. Thus, at the same time sequence frequency, one controllable disconnector can control many LED light strings and dimming branches thereof, thereby reducing the cost. Of course, in the invention, a plurality of LED light strings can share one high-power MOS tube; even if the LED light strings are conducted at the same time, the high-power MOS tube can endure.

The controllable disconnector comprises an isolated MOS tube; the dimming branch comprises a dimming MOS tube. A source electrode of the isolated MOS tube is connected with the LED light string; a drain electrode of the isolated MOS tube is connected with a source electrode of the dimming MOS tube; a gate electrode of the isolated MOS tube is coupled to a power output end of the LED backlight driving circuit. A drain electrode of the dimming MOS tube is coupled to a grounding terminal of the LED backlight driving circuit; a gate electrode of the dimming MOS tube is coupled to a dimming module (not shown in the figure). The MOS tube is used for the controllable disconnector and the dimming branch, which improves the material generality and reduces the cost of designing and purchasing. Of course, the controllable disconnector and the dimming branch can also adopt other modes of the controllable switches, such as a transistor, etc.

In order to compensate for a brightness loss of the whole backlight module, the LED backlight driving circuit further comprises a brightness compensation module, which makes a practical brightness outputted by the conducted LED light string to exceed a preset brightness. Because the successive conduction mode of the LED light string inevitably reduces the brightness of the whole backlight module, the brightness loss of the whole backlight module can be compensated by enhancing the brightness outputted by one LED light string, the average brightness of the invention is almost constant with the brightness in the prior art; the cost is reduced, and display quality is also ensured. In the invention, when the frequency is high enough and the current is slightly enhanced compared with a complete bright mode, the brightness of the module can be kept constant. Thus, few isolated MOS tubes can control a plurality of LED light strings at different time periods; a current of one LED light string is controlled by the isolated MOS at each time period, thereby reducing the number of the isolated MOS tube.

The invention also discloses a method for driving an LED backlight, which comprises the following steps:

A: Sharing one controllable disconnector for at least two LED light strings and dimming branches thereof;

B: Controlling the dimming branch to ensure that only one of the dimming branches connected with the same controllable disconnector can be conducted at the moment. The conducted dimming branch is controlled by a brightness compensation module, which makes a practical brightness outputted by the corresponding LED light string to exceed a preset brightness. Because the successive conduction mode of the LED light string inevitably reduces the brightness of the whole backlight module, a brightness loss of the whole backlight module can be compensated by enhancing the brightness outputted by one LED light string, so that the average brightness of the invention is almost constant with the brightness in the prior art; the cost is reduced, and display quality is also ensured. For the specific conducting mode of the dimming branch, the following two modes can be adopted:

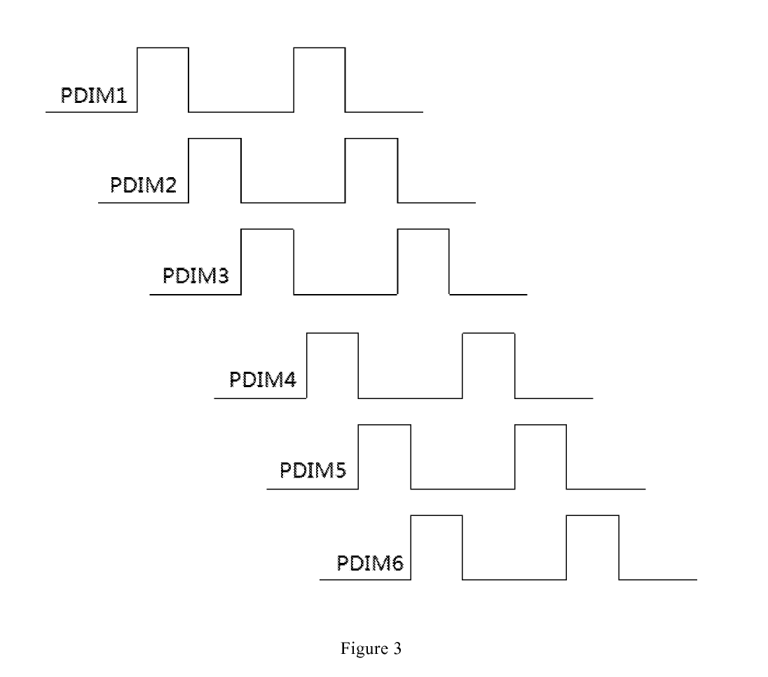

In the step B, the conducting time of one dimming branch is set as a time sequence for controlling the dimming branches connected with the same controllable disconnector to be successively and alternately conducted in the time sequence. As shown in FIG. 2 and FIG. 3, two isolated MOS tubes are used for six LED light strings. A scanning mode is used for a pulse width modulation (PWM), which is from PWM1 to PWM6; when the PWM1 is switched on, the PWM4 is synchronously switched on; at this time, the current of the first and the fourth LED light strings can be properly enhanced for improving the brightness; meanwhile, other LED light strings are in a shutdown mode. Similarly, at the next time sequence, the PWM2 and the PWM5 are synchronously switched on; the current of the second and the fifth LED light strings can be properly enhanced for improving the brightness; meanwhile, other LED light strings are in a shutdown mode, and so on. In the example, at the same time sequence frequency, one controllable disconnector can control many LED light strings and dimming branches thereof, thereby reducing the cost.

In order to simplify the control process, the steps can be added prior to the step A in this mode: computing a reciprocal of a maximum duty cycle of one LED light string; taking an integer of the reciprocal of the maximum duty cycle as the number of the dimming branches connected with one controllable disconnector. Thus, there is no need to deliberately control the conducting time of one dimming branch; as long as the starting time of the dimming branches connected with the same controllable disconnector is successively staggered, the dimming branches connected with the same controllable disconnector will not be conducted at the same time; the control mode is simple. For example, the maximum duty cycle of one LED light string is 1/3, and one period time is T, one controllable disconnector is connected with three dimming branches; the first dimming branch is conducted at T/3; the second dimming branch is conducted at 2T/3; the third dimming branch is conducted at T.

In the invention, the step B can also adopt other control modes; for example, the conducting time of one dimming branch is set as a time sequence for controlling all the dimming branches to be successively and alternately conducted in the time sequence; the control signals PDIM1˜PDIM6 of the dimming branches are successively conducted.

In the invention, because a plurality of LED light strings and dimming branches thereof share one controllable disconnector, as long as only one of dimming branches connected with the same controllable disconnector is conducted at the moment, the controllable disconnector will not perform overload operation. When the switching frequency of the dimming branches is high enough, the whole brightness of the LED light strings will not be obviously reduced. Thus, on the premise of ensuring that the whole brightness is not obviously reduced, the number of the controllable disconnector can be reduced by sharing the same controllable disconnector connected with at least two LED light strings, thereby reducing the cost.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LED backlight driving circuit, comprising: a plurality of LED light strings which are arranged in parallel; wherein each said LED light string is correspondingly connected with a dimming branch in series; said LED backlight driving circuit further comprises a plurality of controllable disconnectors; one end of said controllable disconnector is connected with at least two LED light strings, and the other end of said controllable disconnector is connected with an equal amount of dimming branches; at the moment, only one of the dimming branches connected with the same controllable disconnector can be conducted.

2. The LED backlight driving circuit of claim 1, wherein said LED backlight driving circuit further comprises a brightness compensation module, which makes a practical brightness outputted by the conducted LED light string to exceed a preset brightness.

3. The LED backlight driving circuit of claim 1, wherein said dimming branches connected with the same controllable disconnector are successively and alternately conducted in a time sequence.

4. The LED backlight driving circuit of claim 1, wherein all said dimming branches are successively and alternately conducted in the time sequence.

5. The LED backlight driving circuit of claim 1, wherein said controllable disconnector comprises an isolated MOS tube; a source electrode of said isolated MOS tube is connected with said LED light string; a drain electrode of said isolated MOS tube is connected with said dimming branch; a gate electrode of said isolated MOS tube is coupled to a power output end of said LED backlight driving circuit; said dimming branch comprises a dimming MOS tube.

6. An LCD device, comprising: an LED backlight driving circuit; wherein said LED backlight driving circuit comprises a plurality of LED light strings which are arranged in parallel; each said LED light string is correspondingly connected with a dimming branch in series; said LED backlight driving circuit further comprises a plurality of controllable disconnectors; one end of the controllable disconnector is connected with at least two LED light strings, and the other end of the controllable disconnector is connected with an equal amount of dimming branches; at the moment, only one of the dimming branches connected with the same controllable disconnector can be conducted.

7. The LCD device of claim 6, wherein said LED backlight driving circuit further comprises a brightness compensation module, which makes a practical brightness outputted by the conducted LED light string to exceed a preset brightness.

8. The LCD device of claim 6, wherein said dimming branches connected with the same controllable disconnector are successively and alternately conducted in a time sequence.

9. The LCD device of claim 6, wherein all said dimming branches are successively and alternately conducted in the time sequence.

10. The LCD device of claim 6, wherein said controllable disconnector comprises an isolated MOS tube; a source electrode of said isolated MOS tube is connected with said LED light string; a drain electrode of said isolated MOS tube is connected with said dimming branch; a gate electrode of said isolated MOS tube is coupled to a power output end of said LED backlight driving circuit; said dimming branch comprises a dimming MOS tube.

11. A method for driving an LED backlight, comprising the following steps:
A: Sharing one controllable disconnector for at least two LED light strings and dimming branches thereof;
B: Controlling said dimming branches to ensure that only one of the dimming branches connected with the same controllable disconnector can be conducted at the moment.

12. The method for driving an LED backlight of claim 11, wherein in said step B: the conducted dimming branch is controlled by a brightness compensation module, which makes a practical brightness outputted by the corresponding LED light string to exceed a preset brightness.

13. The method for driving an LED backlight of claim 11, wherein in said step B: the conducting time of one dimming branch is set as a time sequence for controlling all the dimming branches to be successively and alternately conducted in the time sequence.

14. The method for driving an LED backlight of claim 13, wherein prior to said step A: computing a reciprocal of a maximum duty cycle of one LED light string; taking an integer of the reciprocal of the maximum duty as the number of the dimming branches connected with one controllable disconnector.
